(19) United States
(12) Patent Application Publication
(10) Pub. No.: US 2026/0259823 A1
(43) Pub. Date: Sep. 3, 2026

(54) BUG TRACKING TOOL INTERACTIVE CODING ASSISTANT SYSTEM AND METHOD

(71) Applicant: Dell Products L.P., Round Rock, TX (US)

(72) Inventors: Parminder Singh Sethi, Ludhiana (IN); Tamilarasan Janakiraman, Cork (IE); Praveen Kumar, Noida (IN)

(73) Assignee: Dell Products L.P., Round Rock, TX (US)

(21) Appl. No.: 19/066,313

(22) Filed: Feb. 28, 2025

(51) Int. Cl. G06F 11/3698; G06F 8/36

(52) U.S. Cl. CPC G06F 11/3698; G06F 8/36

(57) ABSTRACT

Embodiments of the present disclosure provide a bug tracking tool interactive coding assistant system and method that may be used to leverage an Artificial Intelligence (AI) tool trained on the company's code repositories to provide AI-driven code reuse. According to one embodiment, an Information Handling System (IHS) may include executable instructions to receive, from a user, a feature specification for executable code, and using an Artificial Intelligence (AI) service, analyze a trained AI model to identify a code snippet. The code snippet may then be provided to the user.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Cloud computing refers to a group of network elements providing services on demand, such as data storage and computing power, without directed active management by a user. Cloud computing relies on a sharing of resources to achieve coherence and economies of scale. Cloud computing can be provided as a service over the Internet, such as in the form of “Infrastructure as a Service” (IaaS), “Platform as a Service” (PaaS), and/or “Software as a Service” (SaaS). A Platform as a Service (PaaS) provider allows a consumer to deploy onto the PaaS cloud infrastructure consumer resources created using program language, libraries, services and tools supported by the PaaS provider. The consumer does not manage or control the underlying cloud infrastructure, including the networks, servers, operating systems, or storage, but has control over the deployed applications. Platform as a Service (PaaS) providers offer a computing platform, typically including an operating system, programming language execution environment, database, and web server, and the consumer, or user, develops and runs software on the cloud platform, rather than obtaining and maintaining the underlying hardware and software layers.

Bug tracking tools are a type of an issue tracking tool that keeps track of reported software bugs in software development projects. The bug tracking tool may include a log collector that is configured to collect logs, system state, container statistics, and product configuration information from an application that is being developed or otherwise modified when a software bug is encountered. Conventionally, a developer would prepare a test procedure that contained the requirements of the software being developed. The developer would then apply the procedure and was required to read and understand the procedure completely before coding. In some cases, the developer would create a test script and a draft test execution to produce a test result to review. The developer would then review the test results and provide feedback for modification or improvement using the bug tracking tool.

### SUMMARY

Embodiments of the present disclosure provide a bug tracking tool interactive coding assistant system and method that may be used to leverage an Artificial Intelligence (AI) tool trained on the company's code repositories to provide AI-driven code reuse. According to one embodiment, an Information Handling System (IHS) may include executable instructions to receive, from a user, a feature specification for executable code, and using an Artificial Intelligence (AI) service, analyze a trained AI model to identify a code snippet. The code snippet may then be provided to the user.

According to another embodiment, a bug tracking tool Interactive coding assistant method includes the steps of: receiving, from a user, a feature specification for executable code, using an Artificial Intelligence (AI) service, analyzing a trained AI model to identify a code snippet, and providing the identified code snippet to a user.

According to yet another embodiment, a non-transitory memory storage device has program instructions stored thereon that, upon execution by an Information Handling System (IHS), cause the IHS to: receive, from a user, a feature specification for executable code, using an Artificial Intelligence (AI) service, analyze a trained AI model to identify a code snippet, and provide the identified code snippet to a user.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement a software identity and integrity securing system and method for a software identity issuance agent according to one embodiment of the present disclosure.

FIG. 2 illustrates an example bug tracking tool interactive coding assistant system that may be used to leverage an Artificial Intelligence (AI) service trained on existing code repositories to provide AI-driven code reuse according to one embodiment of the present disclosure.

FIG. 3 illustrates an example interactive coding assistant method that may be used to identify and suggest executable code using an AI service according to one embodiment of the present disclosure.

FIGS. 4 and 5 illustrate example code snippets that have been generated by the bug tracking tool interactive coding assistant system of FIG. 2.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

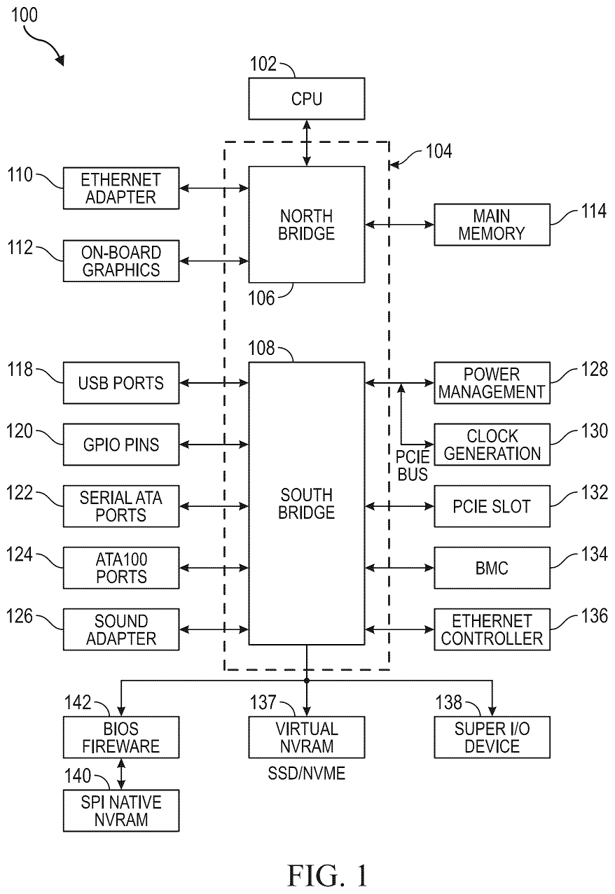

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Developers generally describe an occupation that involves the generation of executable software (e.g., code) for storing in a memory and executing on one or more processors. Developers often create new code instead of reusing existing code due to unawareness of available resources. Traditional bug tracking tools, such as JIRA or BUGZILLA, lack features to assist in identifying reusable code, leading to increased development time and effort (e.g., churn). As such, duplication of effort can often result in an inconsistent codebase. Use of the bug tracking tool involves the generation of a ticket for each software bug that is found, and may include information about the problem exhibited, and snippets of code that caused the software bug as well as snippets of code that fixed the software bug.

As will be described in detail herein below, embodiments of the present disclosure provide a bug tracking tool interactive coding assistant system and method that may be used to leverage an Artificial Intelligence (AI) tool trained on the company's code repositories to provide AI-driven code reuse. The AI tool communicates with a bug tracking tool via an Application Program Interface (API) to provide relevant code snippets and explanations for reuse. The AI tool automatically updates bug tracking tool tickets with code suggestions to streamline the development process.

FIG. 1 shows an example IHS 100 that may be configured to implement a software identity and integrity securing system and method for a software identity issuance agent according to one embodiment of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 126, Ethernet controller 136, and one or more general purpose input/output (GPIO) pins 120. Southbridge 108 may also provide a bus for interfacing peripheral card devices such as PCIe slot 132. In some embodiments, the bus may include a peripheral component interconnect (PCI) bus. Southbridge 108 may also provide baseboard management controller (BMC) 134 for use in managing the various components of the IHS 100. Power management circuitry 126 and clock generation circuitry 130 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 122 and/or an ATA100 adapter for providing one or more ATA100 ports 124. Serial ATA ports 122 and ATA100 ports 124 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 132, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 142 that includes BIOS program code containing the basic routines that help to start up the IHS 100 and to transfer information between elements within the IHS 100. BIOS/firmware 142 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 142 to store configuration data for the IHS 100. In other embodiments, configuration data for the IHS 100 may be stored on the same virtual NVRAM 137 as BIOS/firmware 142. The IHS 100 may also include a SPI native NVRAM 140 coupled to the BIOS/firmware 142.

BMC 134 may include non-volatile memory having program instructions stored thereon that enable remote management of the IHS 100. For example, BMC 134 may enable a user to discover, configure, and manage the IHS 100, setup configuration options, resolve and administer hardware or software problems, etc. Additionally or alternatively, BMC 134 may include one or more firmware volumes, each volume having one or more firmware files used by the BIOS' firmware interface to initialize and test components of the IHS 100.

As a non-limiting example of BMC 134, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

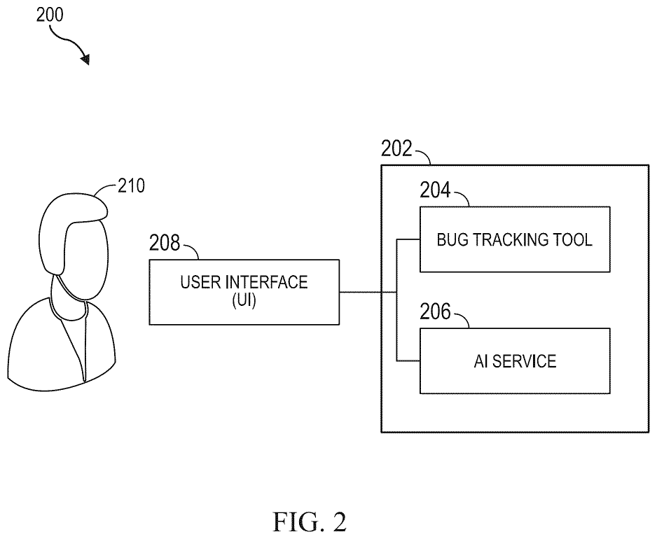

FIG. 2 illustrates an example bug tracking tool interactive coding assistant system 200 that may be used to leverage an Artificial Intelligence (AI) service trained on existing code repositories to provide AI-driven code reuse according to one embodiment of the present disclosure. The bug tracking tool interactive coding assistant system 200 includes a bug tracking tool Interactive coding assistant 202 configured with a bug tracking tool 204 and an AI service 206. The bug tracking tool 204 keeps track of reported software bugs in software development projects, and may be accessed by a User Interface (UI) 208 to provide information about bugs to a user 210. According to embodiments of the present disclosure, the AI service 206 may be trained on a development process's code repositories to provide AI-driven code reuse by updating bug tracking tool tickets with code suggestions to streamline the development process.

Embodiments of the present disclosure may provide advantages over conventional bug tracking tools. For example, the bug tracking tool interactive coding assistant system 200 combines the AI service 206 with the bug tracking tool 204 to automate code reuse. Additionally, AI service 206 automatically updates bug tracking tool tickets with relevant code suggestions, and provides continuous improvement of the AI model based on developer feedback, enhancing future suggestions. The bug tracking tool interactive coding assistant system 200 may also use the AI service 206 to analyze feature specifications to provide contextually relevant code snippets. Conventional bug tracking tools, such as JIRA track tasks but do not assist in identifying reusable code. Also with the conventional bug tracking tools, developers were often required to manually search code repositories, which is time-consuming and inefficient. Thus, existing solutions are not integrated with the bug tracking tools and lack automation.

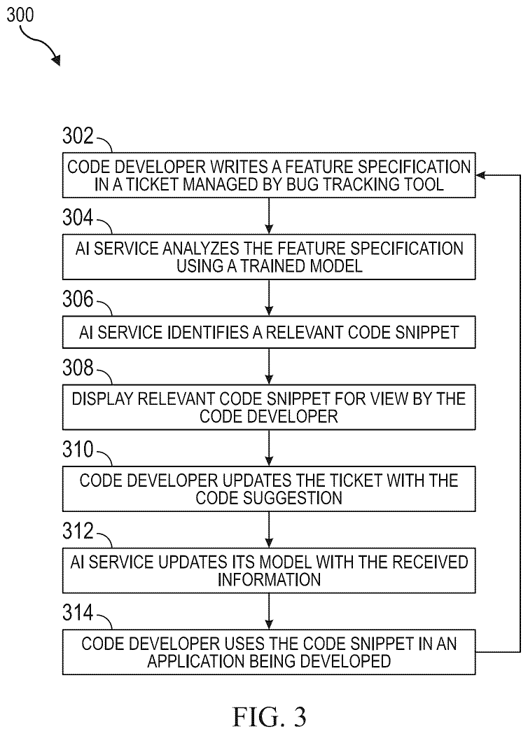

FIG. 3 illustrates an example interactive coding assistant method 300 that may be used to identify and suggest executable code using an AI service according to one embodiment of the present disclosure. Additionally or alternatively, the interactive coding assistant method 300 may be performed by the bug tracking tool interactive coding assistant system 200 shown and described above with reference to FIG. 2. Initially, the AI service 206 may generate a trained AI model using a code repository used by the developer, such as an organization or company the produces the code for use by others.

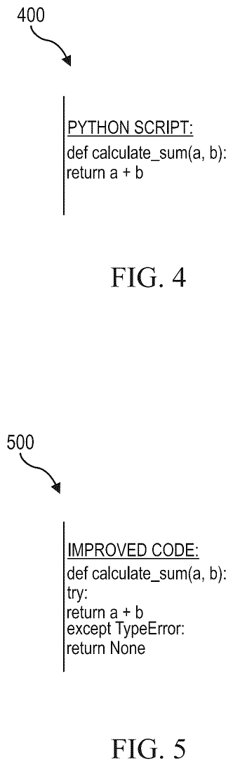

At step 302, the code developer 210 writes a feature specification in a ticket managed by bug tracking tool. The feature specification may include, for example, a particular computer operation, and it may be written in prose. In one embodiment, the feature specification may include a particular programming language (e.g., C, Python, Pascal, etc.) to use. At step 304, the AI service 206 analyzes the feature specification using the trained AI model. The AI service 206 then identifies a relevant code snippet at step 306. For example, the feature specification may involve adding two numbers. As such, the AI service may identify a code snippet 400 such as shown in FIG. 4.

Referring again to FIG. 3, the AI service 206 displays a relevant code snippet for view by the code developer at step 308. In one embodiment, the AI service 206 may display the code snippet on the same user interface 208 as is used by the bug tracking tool 204. At step 310, the AI service 206 receives a suggestion from a user (e.g., code developer updates the ticket with the code suggestion. In one embodiment, the code developer may include in the ticket, an explanation how and/or why the code snippet did, or did not, solve a bug problem. That is, the code developer reviews the code snippet and provides feedback. Given the previous example where the code developer requested a code snippet to add two numbers, the code developer 210 may suggest adding error handling. As such, the AI service 206 may suggest a code snippet as shown in FIG. 5.

At step 312, the AI service 206 updates its trained AI model with the newly received information, such as to improve its performance on ensuing requests. At step 314, the code developer 210 uses the code snippet in an application being developed. The aforedescribed process may be continually repeated for continual improvement of the trained AI model. Nevertheless, when use of the interactive coding assistant method 300 is no longer needed or desired, the process ends.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor;
a memory coupled to the processor, the memory having program instructions that, upon execution by the processor, cause the IHS to:
receive, from a user, a feature specification for executable code;
using an Artificial Intelligence (AI) service, analyze a trained AI model to identify a code snippet; and
provide the identified code snippet to a user.

2. The IHS of claim 1, wherein the program instructions, upon execution by the host processor, further cause the IHS to obtain the feature specification from a ticket of a bug tracking tool.

3. The IHS of claim 2, wherein the program instructions, upon execution by the host processor, further cause the IHS to receive, from the user, in the ticket of the bug tracking tool, an explanation how or why the code snippet did, or did not, solve a bug problem.

4. The IHS of claim 2, wherein the program instructions, upon execution by the host processor, further cause the IHS to provide the code snippet to the user via a user interface of the bug tracking tool.

5. The IHS of claim 1, wherein the feature specification comprises a particular programming language to use.

6. The IHS of claim 1, wherein the feature specification comprises a computer operation written in prose.

7. The IHS of claim 1, wherein the program instructions, upon execution by the host processor, further cause the IHS to train an AI model for use with the AI service using an existing code repository.

8. A bug tracking tool Interactive coding assistant method comprising:
receiving, from a user, a feature specification for executable code;
using an Artificial Intelligence (AI) service, analyzing a trained AI model to identify a code snippet; and
providing the identified code snippet to a user.

9. The bug tracking tool Interactive coding assistant method of claim 8, further comprising obtaining the feature specification from a ticket of a bug tracking tool.

10. The bug tracking tool Interactive coding assistant method of claim 9, further comprising receiving, from the user, in the ticket of the bug tracking tool, an explanation how or why the code snippet did, or did not, solve a bug problem.

11. The bug tracking tool Interactive coding assistant method of claim 9, further comprising providing the code snippet to the user via a user interface of the bug tracking tool.

12. The bug tracking tool Interactive coding assistant method of claim 8, wherein the feature specification comprises at least one of a particular programming language to use, or a computer operation written in prose.

13. The bug tracking tool Interactive coding assistant method of claim 8, further comprising training an AI model for use with the AI service using an existing code repository.

14. A non-transitory memory storage device having program instructions stored thereon that, upon execution by an Information Handling System (IHS), cause the IHS to:
receive, from a user, a feature specification for executable code;
using an Artificial Intelligence (AI) service, analyze a trained AI model to identify a code snippet; and
provide the identified code snippet to a user.

15. The non-transitory memory storage device of claim 14, wherein the program instructions, upon execution by the host processor, further cause the IHS to obtain the feature specification from a ticket of a bug tracking tool.

16. The non-transitory memory storage device of claim 15, wherein the program instructions, upon execution by the host processor, further cause the IHS to receive, from the user, in the ticket of the bug tracking tool, an explanation how or why the code snippet did, or did not, solve a bug problem.

17. The non-transitory memory storage device of claim 15, wherein the program instructions, upon execution by the host processor, further cause the IHS to provide the code snippet to the user via a user interface of the bug tracking tool.

18. The non-transitory memory storage device of claim 14, wherein the feature specification comprises a particular programming language to use.

19. The non-transitory memory storage device of claim 14, wherein the feature specification comprises a computer operation written in prose.

20. The non-transitory memory storage device of claim 14, wherein the program instructions, upon execution by the host processor, further cause the IHS to train an AI model for use with the AI service using an existing code repository.
